(19) United States
(12) Patent Application Publication
(10) Pub. No.: US 2012/0204909 A1
(43) Pub. Date: Aug. 16, 2012

(54) Removing Dust Using A Hand Pump

(76) Inventor: Ray Arjomand, Sparks, NV (US)

(21) Appl. No.: 13/371,458

(22) Filed: Feb. 12, 2012

Related U.S. Application Data
(63) Continuation-in-part of application No. 12/218,828, filed on Jul. 21, 2008, now abandoned.

(51) Int. Cl. A47L 5/02; A47L 9/28; B08B 5/02; A47L 9/30

(52) U.S. Cl. 134/37; 15/405; 15/324; 15/339

(57) ABSTRACT

A manual air hand pump operated and powered by two hands of a user for blowing dust and debris from computer related equipment and accessories. The hand pump contains a cylinder, a handle, a piston movable inside the cylinder, and a cone shaped nozzle. The piston is attached to the handle at the first end of the cylinder; and the cylinder has the nozzle at the second end of the cylinder. The cone shaped hollow nozzle has a hole or opening at its tip of ideal size for blowing dust and debris from electronics, computer related equipment, and for general use in a clean manufacturing environment. A battery operated or rechargeable shake or crank flashlight or crank low voltage electric generator may also be attached to or combined with the pump to make it multifunctional and add to its utility.

### CROSS-REFERENCE TO RELATED APPLICATIONS

This application is a continuation-in-part of application Ser. No. 12/218,828, filed Jul. 21, 2008 of application Ser. No. 10/961,603 filed Oct. 12, 2004, which corresponds in subject matter to Disclosure Document No. 535537, entitled “Manual Air Pump For Removing Dust”, dated Jul. 28, 2003 and relies on the filing date of Jun. 27, 2011 for Provisional Application Ser. No. 61/571,475, entitled “Manual Dust Pump Rechargeable Flashlight or Charger” and the filing date of Oct. 14, 2003 Provisional Application Ser. No. 60/511,156 all incorporated herein by reference.

### STATEMENT REGARDING FEDERALLY SPONSORED RESEARCH OR DEVELOPMENT

Not applicable

### REFERENCE TO SEQUENTIAL LISTING, A TABLE, OR A COMPUTER PROGRAM LISTING APPENDIX SUBMITTED ON A COMPACT DISC

Not applicable

### FIELD OF THE INVENTION

The present invention generally relates to a manual hand pump operated and powered by a user for blowing dust and debris from computer related equipment. It is a method or process for removing dust and debris from electronics and computer related equipment and for use in clean manufacturing using a manual hand air pump. The present invention is also directed to air pumps useful in carrying out the method of the invention. A crank or manual electric generator, flashlight, laser pointer or other low voltage gadgets may also be attached to or incorporated therein to enhance its utility and usefulness.

### BACKGROUND OF THE INVENTION

In the USA, more than 35 million compressed air cans are sold annually primarily used for dusting computer equipment. Because of the generic name “canned air”, some people mistakenly believe that the can only contains normal air or contains a less harmful substance such as nitrous oxide. However, the gases actually used are denser than air, and inhaling can lead to paralysis, serious injury, or death. Recently, in the United States and Canada stores have begun to ask for ID to verify that the customer is 18 years or older. When inverted to spray liquid, the boiling fluorocarbon aerosol is easily ignitable, producing a very large blast of flame and extremely toxic byproducts such as hydrogen fluoride and carbonyl fluoride as a combustion product.

Fluorocarbons, although they replaced the older set of more flammable hydrocarbons, can still combust relatively easily, e.g., by holding a source of fire to the escaping fluid. They do, however, have a lower chance of exploding in a closed container by means of spontaneous combustion.

The liquid, when released from the can, boils at a very low temperature, rapidly cooling any surface it touches. This can cause frostbite on contact with skin, damage electronics, monitors, eyeglasses and discolor plastic keyboards. As the can gets very cold during extended use, holding the can itself can result in frostbite. Since gas dusters are often contained in pressure vessels, they are considered explosively volatile.

Environmental impacts. Difluoroethane (HFC-152a), trifluoroethane (HFC-143a), and completely non-flammable tetrafluoroethane (HFC-134a) are potent greenhouse gases. According to the Intergovernmental Panel on Climate Change (IPCC), the global warming potential (GWP) of HFC-152a, HFC-143a, and HFC-134a are 124, 4470, and 1430, respectively.[1] GWP refers to global warming effect in comparison to CO2 for unit mass. 1 kg of HFC-152a is equivalent to 124 kg of CO2[2] Gas dusters sold in many countries are ozone safe as they use zero-ODP gases; however, this is a separate issue from the global warming concern.

Besides causing global warming, the disposable air cans fill landfills wasting natural resources and damaging the environment. In addition the cans are relatively expensive, the air velocity and volume drops after some use and they do not come with any type of money back guarantee after use.

U.S. Pat. No. 5,335,703 entitled “Rechargeable Dust-off Device And Method Of Using The Device” discloses a rechargeable air can. The device may be repetitively filled with compressed air using a valve which allows a bike pump or gas station pump to fill the device. Alternatively, a built-in pump connected to an inlet valve in the chamber may be implemented for introducing compressed air into the device. U.S. Pat. No. 4,874,404, entitled “Vacuum Cleaner,” features an Electric Vacuum Cleaner that uses water to filter out and remove dust. U.S. Pat. No. 5,531,722, entitled “Aspiration Unit,” applies to a device connected to an ultrasonic scaler that includes a novel suction device for carrying water and debris generated during scaling procedures away from a work site. U.S. Pat. No. 2,968,441, entitled “Spray Nozzle Assembly for Use with Aerosol Can,” covers a nozzle assembly and attachment that allows the user to spray directly and accurately on a location that is unavoidably separated from the can by various objects and structures. U.S. Pat. No. 5,989,360 entitled “Gas-Driven Portable Self-contained Vacuum Device,” features an attachment to a condensed air can that converts it into a vacuum device.

U.S. Patent Application Publication No. U.S. 2001/0038798 A1, dated Nov. 8, 2001 entitled “Portable Hand Operated Fluid Pump,” to Francis X. Foster uses a squeezable bladder that is used with one hand. It does not have a conical nozzle and has multiple valves (unidirectional intake orifice 12 and unidirectional exhaust orifice 13) used for inflating recreational equipment. Without the valves the air will escape the inflatable object upon release of the squeezable bladder.

U.S. Pat. No. 5′433,136, dated Jul. 18, 1995 entitled “Hand Pump With Handle Storage Compartment,” to Tsai Lung-Po describes a conventional hand pump for inflating recreational equipment.

As explained in applicant's Provisional Patent Application dated Jun. 27, 2011, Application No. 61/571,475 entitled “Manual Dust Pump Rechargeable Flashlight or Charger”, in the early 1830s, a scientist named Michael Faraday discovered that by passing a magnet through a coil of wire, a small electric current is created. The same thing happens when a person charges a shake flashlight. A magnet passes back and forth through a coil of wire and creates an AC electric current that is converted to DC current with a rectifier and is stored in a capacitor. When the flashlight is turned on, the capacitor supplies the stored energy to the bulb much like a battery-powered light. The capacitor stores the power that is generated while shaking the flashlight. Unlike a battery, the capacitor can be recharged almost indefinitely, will operate even in hot or cold environments and will not corrode. The generated electricity may be stored in a capacitor or a rechargeable battery. The stored electric energy is then used to power USB devices, cell phones, radios, Portable Media Players, DVDs etc. The manual chargers on the market today have various types of electric connectors that the various electronic devices and gadgets can connect or plug into.

Dust typically includes particles such as plant pollen, human and animal hairs, textile fibers, paper fibers, minerals from outdoor soil, human skin cells, and many other things. Standard dusting devices are often inadequate for reaching small spaces and partially covered areas in intricate electronic or computer equipment. For example a computer keyboard regularly collects dust, debris, and deposits underneath it's keys as things migrate between the small open spaces between the keys. Additionally debris and particles heavier than dust, such as sand, pieces of metal, glass or plastic, food debris and many other things can migrate into hard to reach areas. Other applications include automotive technologies and clean manufacturing. Typical dust as well as these heavier particles can also become embedded in surface deposits such as grease deposits, adhesive residues, oily deposits and other residues that may preexist or collect by leakage, spillage. and contact with a users unclean hands. Herein when used in relation to the function of the disclosed invention, the term dust generally refers to the aforementioned non-exhaustive list of dust particles, debris generally, and heavier than dust particles or embedded particles.

### SUMMARY OF THE INVENTION

The present invention has been accomplished to provide a hand pump which eliminates the aforesaid drawbacks. More particularly it is a device, method, and process for removing dust or debris and heavier than dust or embedded debris using a manual hand air pump. It is particularly useful for removing dust and debris from electronic equipment, computers, and computer related equipment such as keyboards, printers, faxes and monitors, and automotive and machine technologies. It is also useful in a clean manufacturing or sterile setting where objects need to be kept free of dust or contaminates. Using manual power is a powerful green alternative to compressed air cans, eliminates the many risks associated with canisters containing compressed high pressure contents, and have a much longer span of use. Importantly manual power provides for variable control of the strength of the air blast allowing the user to take into account the delicacy of the equipment or electronics involved, allowing for a soft stream of air when needed as well as a forceful blast higher than air canisters when needed. A crank or manual electric generator, flashlight, laser pointer or other low voltage gadgets may also be attached to or incorporated therein to enhance its utility and usefulness.

None of the cited references suggest making any physical improvement or change to the nozzle of a standard hand pump used for inflating recreational objects to enable it to produce a more powerful, higher velocity blast of air adapted for improved dusting electronics and computer related equipment. In addition the higher velocity blast of air is capable of removing debris and particles heavier than dust, such as sand, pieces of metal, glass or plastic, food debris as well as dust and heavy particles embedded in grease, adhesives, oily deposits and other residues.

### BRIEF DESCRIPTION OF THE DRAWINGS FIGURES

Above are drawings to demonstrate a hand pump used mainly for removing dust and debris as disclosed herein. It should be understood that the description and drawings disclose specific embodiments and are for purposes of illustration only. There my be other modifications and changes obvious to those of ordinary skill in the art which fall within the scope of the present invention. For example the hand pump may have a different form or shape from illustrations below. Since there are hundreds of different shapes and models of manual pumps on the market today, one cannot incorporate all of them in this application. With exceptions to be pointed out below, the shape or form of the manual hand pump is not the subject of this invention, but its use for removing dust and debris is.

For the purpose of illustrating the invention, the attached drawings show several embodiments that are presently preferred. However, it should be understood that the invention is not limited to the precise arrangement, instrumentality or embodiment shown in accompanying drawings

FIG. 1 is a vertical cross-sectional view of a first embodiment of a manual air pump having two handles and a stiff or flexible tube connected to the outlet port used for removing dust from computer parts by blowing and vacuuming.

FIG. 2 is a vertical cross-sectional view of a second embodiment of a manual air pump showing the piston moving down to force the air out the front outlet port to clean dust from computer parts by blowing (in one embodiment).

FIG. 3 is a vertical cross-sectional view of a second embodiment of a manual air pump showing the piston moving up and filling the cylinder with air through the side inlet ports.

FIG. 4 is a vertical cross-sectional view of a third embodiment of a manual air pump with the piston moving up and filling the cylinder with air through the front inlet port to remove dust from computer parts by vacuuming.

FIG. 5 is a vertical cross-sectional view of a third embodiment of a manual air pump with a piston moving down to force dust-laden air out the side outlet ports.

FIG. 6 is a vertical cross-sectional view of a fourth embodiment of a manual vacuum pump having a dust container and anti-static wire attachment.

FIG. 7 is a side elevational view of a fifth embodiment of a manual pump.

FIG. 8 is a cross-sectional view of the hand pump with a rechargeable flashlight that operates similar to shake flashlights attached to its outer cylinder.

FIG. 9 is a cross-sectional view of the hand pump with a rechargeable crank flashlight attached to its outer cylinder.

FIG. 10 shows results from performance tests (See Forensic Engineering Report below) were performed on 4 SDP (Super Dust Pump, the present invention) 3 BP (ball pumps) and 2 brands of “canned air1” containers. 1 C1: Century Duster™ by Century Laboratories and C2: Dust-Off Professional by Falcon Safety Products, Inc. C1 propellant is Difluoroethane, CAS #75-37-6, a flammable inhalation hazard. C2 propellant is also Difluoroethane. The SDP discharged Vp (air velocity pressure) of 11.36″ to 14.5″ w.c. (water column) exceeded that from the BP (6.42″ w.c.) and was equal to, and can be shown to be higher than, the initial gas discharged Vp from the canned air. The SDP and BP discharge Vp are independent of ambient air temperature. The canned air's gas discharge Vp is dependent on propellant fluid temperature. After the initial canned air discharge, the gas discharge Vp falls off dramatically as the fluid temperature (in the can) decreases. The propellant fluid temperature is initially at ambient air temperature (if there is no radiant heat). As gas vapor is discharged from the can, the vapor pressure in the can drops which allows rapid evaporation of Difluoroethane, the propellant liquid. The Difluoroethane vapor is a flammable inhalant hazard. As evaporation occurs the propellant liquid's temperature drops. Consequently, the rate of evaporation slows and the pressure in the can falls . . . and the gas discharge velocity from the can decreases. There is no operator control over the gas discharge velocity: it is initially high (initial discharge pulse) and rapidly falls off.

The SDP discharged air velocity is directly dependent upon the speed that the pump is operated. Push the handle slowly for a lower air discharge velocity. Push the handle rapidly for a higher air discharge velocity. This relationship remains constant for the entire time the SDP is used.

### DETAILED DESCRIPTION OF THE INVENTION

Disclosed is a hand pump operated and powered manually by a user for blowing dust and debris from computer related equipment, electronic equipment, and objects and surfaces in a sensitive manufacturing environment. As is disclosed herein the pump is made of a cylinder having a first end and a second end, a handle, a piston movable inside the cylinder, and a nozzle; the piston attached to the handle at the first end of the cylinder; and the cylinder has the nozzle at the second end of the cylinder; wherein the nozzle is conical in shape; operating the hand pump by holding the pump so that the nozzle of the hand pump is close to the computer related equipment; and pushing the handle so that the handle pushes the piston along the cylinder so as to create a manually controllable blowing of air out of the nozzle, thereby blowing dust and debris from the from the desired area. There are numerous advantages and differences as described below. Functionally these embodiments have a lower cost of manufacturing to alternatives, are environmentally friendly, provide for variable user controlled air force, and are capable of a higher velocity of air released allow for not only dust removal but removal of heavier particles or embedded particles. Numerous additions and attachments are possible and are disclosed. Certain embodiments are described below, however are not an exhaustive list of possible variations. A clean manufacturing environment generally refers to manufacturing facilities or areas that are kept isolated and separate from the environment such as clean rooms, sterile rooms, sterile hoods and other designs that are used in specialized manufacturing situations such as those used in drug and biologics production, computer chip manufacturing and certain food productions for example.

There are four major physical differences between a standard hand pump's nozzle (used for inflating objects such as bike tires and balls) and the present invention's nozzle.

#1. The standard hand pump used for inflating objects has a flat nozzle whereas the present invention's nozzle is cone shaped to improve air flow.

#2. The standard hand pump used for inflating objects has a 1-way valve inside its nozzle to prevent air from exiting the inflatable object on the back stroke of the hand pump's piston through its cylinder. Typically, a small steel ball in the nozzle acts as a check valve, blocking air from returning to the cylinder of the pump on the backstroke. Without this valve, the air pumped into the inflatable object will exit (escape) it through the pump's nozzle on the backstroke. This valve (the small steel ball in the nozzle) disburses the air coming out of the rectangular slot (not round) nozzle opening the nozzle resulting in reduced air concentrated direction, velocity and volume.

The present invention's nozzle opening is round and does not require a valve therein to function ideally, resulting in increased concentrated air flow and air velocity out of the nozzle and Significant reduction in manufacturing cost.

#3. The standard hand pump's nozzle used for inflating objects must securely couple-fit into an inflatable object's valve that most likely is manufactured by a different company. Since there are many different manufacturer's for different inflatable objects, the hand pump's nozzle must comply with ISO and international standards (please see below for more information on ISO).

The present invention's nozzle does not couple to any inflatable object and therefore does not have to comply with any standards. This results in additional reduction in manufacturing cost associated with compliance.

#4. The standard hand pump's nozzle opening size (hole at the tip of the nozzle) is a rectangular slot (not round) ideal only for inflating objects, not dusting. This shape and size is different from an ideal size opening for removing dust and debris from computer related equipment. The size of the opening (diameter of the round hole at the tip of the nozzle) varies proportionally with the size of the pump and has significant impact on air volume and air velocity out of the nozzle resulting in superior performance when removing dust from computer related equipment.

The hand air pumps used for inflating objects must couple and fit perfectly to the valve of the inflatable object regardless of manufacturing brand or manufacturer's national origin.

For example the standard “Schrader valve” (also called American valve) is a brand of pneumatic tire valve used on virtually every motor vehicle including most wider rimmed bicycle tires in the world today. Generally, all Schrader valves used on tires have threads and bodies of a single standard size at the exterior end, so caps and tools generally are universal for the valves on all common applications.

Another universal valve standard is the Presta valve (also called Sclaverand valve or French valve) is a valve commonly found in high pressure road style and many mountain bicycle inner tubes. It comprises an outer valve stem and an inner valve body. The standard Presta valve has an external thread. An adaptor can be fitted onto this external thread to permit the Presta valve to be connected to a pump with a Schrader chuck. The same adaptor, because of a coincidence of thread sizes, can convert a direct-fitting Schrader pump into one that can connect to flexible adaptors of either kind

A number of industry standards exist for bicycle components to help make spare parts exchangeable. The International Organization for Standardization, ISO, has a special technical committee for cycles, TC149, that has the following scope: “Standardization in the field of cycles, their components and accessories with particular reference to terminology, testing methods and requirements for performance and safety, and interchangeability.”

CEN, European Committee for Standardization, also has a specific Technical Committee, TC333, that defines European standards for cycles. Their mandate states that EN cycle standards shall harmonize with ISO standards. There are many different styles, makes, and models of manual air pumps. The purpose of standardization is to enable hand pumps and tire (inflatable objects) valves manufactured by different companies in different nations couple together and fit interchangeably.

### OBJECTS AND ADVANTAGES

Some of the advantages of the present invention over a compressed air can include:

1. Unlike the compressed air can, this invention, presently available on Amazon.com comes with 45-day money back guarantee.

2. Using manual power, in some embodiments using both hands, it is a powerful green alternative to compressed air cans. It does not harm the earth's ozone layer nor release any greenhouse gases that cause global warming. Since it's reusable it does not fill landfills.

3. Unlike the compressed air can, the present invention's air volume and velocity does not drop over time. And the air is not toxic nor flammable.

4. Unlike the compressed air can, it is not necessary to eject extreme cold liquid causing frostbite upon skin contact, discolor and damage plastics such as eyeglasses, monitors and keyboards.

5. There is no operator control over the gas discharge velocity of the air can. It is initially high and rapidly falls off. The present invention's discharged air velocity is directly dependent upon the speed that the pump is operated. Push the handle slowly for a lower air discharge velocity. Push the handle rapidly for a higher air discharge velocity. This relationship remains constant for the entire time it is used.

The following are some of the advantages of the present invention over a hand air pump used for inflating objects:

1. The standard hand pump used for inflating objects has a 1-way valve inside its nozzle to prevent air from exiting the inflatable object on the back stroke of the hand pump's piston through its cylinder. The present invention does not require any valve in its nozzle. This results in reduction in manufacturing cost and superior concentrated air flow volume and air velocity ideal for removing dust and debris from computer related equipment.

2. Unlike a hand pump that is used for inflating objects, the present invention does not have to fit into or couple with any inflatable object (such as a tire or ball valve). Therefore it does not have to comply with any ISO or international standards resulting in significant additional reduction in manufacturing cost.

3. The present invention's cone shaped nozzle, and the round (not rectangular slot like in a conventional bike or ball pump) nozzle's tip opening hole is made of ideal size for superior concentrated air volume and velocity ideal for dusting computer related equipment and accessories.

These physical differences in the nozzle: (1) having no valve required in the nozzle to function ideally, (2) having a cone shaped nozzle, and (3) a wider hole at the tip of the cone shaped nozzle, makes the present invention ideal for dusting computer related equipment at a reduced manufacturing cost. These physical differences when combined produce a superior synergistic pump that is not only physically different, less expensive to manufacture, but is better suited, and produces a larger volume of air and higher velocity of air ideal for dusting electronics and computer related equipment and removing particles heavier than dust and residue embedded particles than does a conventional hand pump used for inflating objects and equipment.

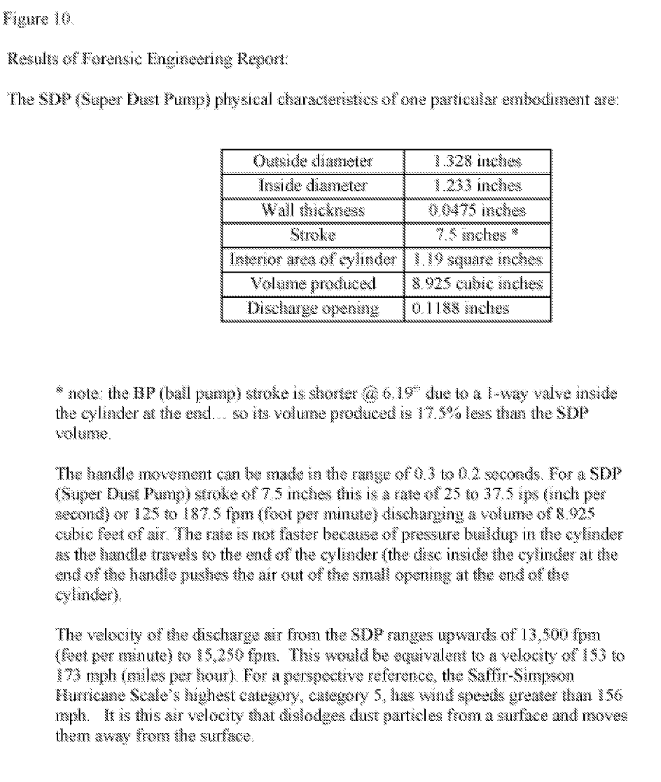

According to scientific test results conducted by Forensic Engineering Report (see FIG. 10—Forensic Engineering Report prepared by Mr. Joe M. Beard, P. E. [Registration expires: Dec. 31, 2012 Lic. No. 003706ME NV. State Board Professional Engineers 1755 E Plumb Ln, Reno, Nev. 89502 Phn: (775) 688-1231]) the present invention's air velocity pressure was more than double that of an identical size ball pump.

“The velocity of the discharge air from the SDP (present invention) ranges upwards of 13,500 fpm to 15,250 fpm. This would be equivalent to a velocity of 153 to 173 mph (miles per hour). For a perspective reference, the Saffir-Simpson Hurricane Scale's highest category, category 5, has wind speeds greater than 156 mph. It is this air velocity that dislodges dust particles from a surface and moves them away from the surface.”

Electric vacuums either plug into wall outlets or are powered by batteries. Bulky, heavy electric vacuums are not suitable for removing dust from sensitive electronics. Some of the advantages of the present invention over electric vacuum cleaners are:

1) A hand pump operated and powered manually can provide a greater volume and velocity of air out of the nozzle than battery or USB powered vacuum.

2) There are no tangling electric wires nor expensive disposable batteries required. It only weighs 4-5 OZs. It is more convenient, faster and easier to operate.

3) The user has control over the air pressure created by the hand pump allowing for variable air velocity.

4) The pumping action provides a good hand exercise while cleaning.

5) In an alternative embodiment, to make the pump multi-functional, the nozzle is attached to the cylinder through a screw joint so that the nozzle can be replaced with a different nozzle that is for inflating objects. Additionally a brush or a scraper blade may be affixed near the tip of the nozzle for dislodging small particles from computer related equipment. According to another aspect of the present invention, a manual crank low voltage electric generator or flashlight (either battery powered or rechargeable) may also be attached to the pump to increase its utility and usefulness. The manual low voltage electric generator can then provide power to a radio, USB port, cell phones, rechargeable batteries, sirens and other portable electronic devices.

The shake rechargeable flashlight of prior art assembly and housing, including the capacitor, rectifier and other electrical components of prior art shake flashlight is moved from the inside to the outside of the pump's cylinder. The inside of the cylinder is empty except for coiled wire wrapped inside the pump's cylinder wall. The magnet is attached to the head of pump's piston so that as the piston moves through the cylinder, the magnet passes through the electric coil thereby generating electricity. The generated electricity is then stored in a capacitor or a rechargeable battery. When the user turns on the flashlight with the flashlight's On/Off switch, the charged capacitor discharges, releasing its stored electricity through wires attached to the flashlight's bulb, thereby lighting the bulb.

Some of the advantages of the dust pump rechargeable flashlight over shake rechargeable flashlight include:

#1. The dust pump flashlight uses both hands (one to hold the cylinder and the other to push and pull the piston inside the cylinder). Using both hands is easier, less tiring and generates greater force.

#2. Since the shake flashlight has to be shaken to get charged, it must be built very strong (like a shock absorber) to absorb a great amount of physical stress. The dust pump flashlight need not be shaken. Only the piston moves within the cylinder. Therefore it's subject to less stress, lasts longer and/or costs less to manufacture.

#3. Multi-Purpose-Functional: When the present invention combined with a flashlight is used for dusting, it also charges the flashlight. With the Shake Flashlight, while the flashlight is getting charged (shaken) no useful work is done.

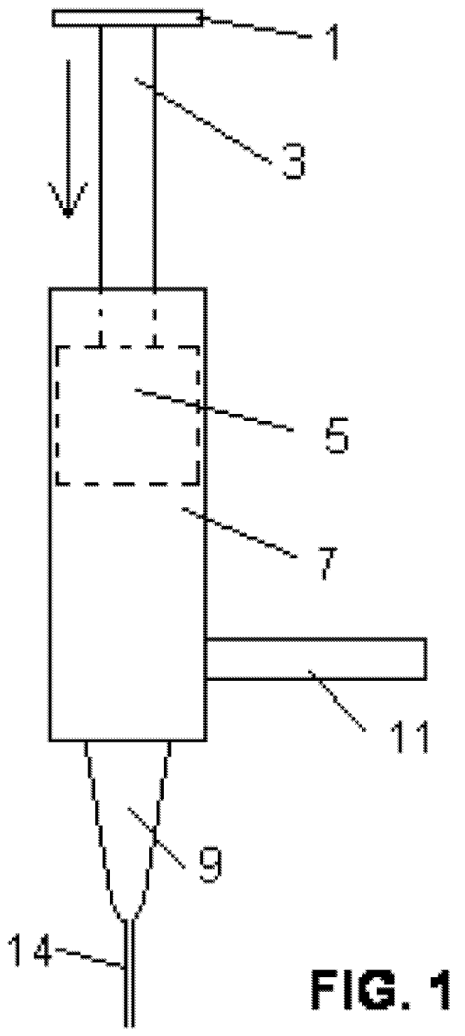

The first embodiment will be described with reference to FIG. 1. Directions of airflow throughout the following descriptions will be given in agreement with the directions shown in the drawings. In the following descriptions, “forward” refers to the direction which is toward the nozzle and “rearward” refers to the direction which is toward the handle. FIG. 1 is an example of a manual air pump for removing dust from computer related equipment such as keyboards, printers, scanners, copiers and monitors. The air pump has two handles 1, 11. The first handle 1 is attached to a bar 3 that is attached to a piston 5 which has a proximal end and a distal end. The piston 5 moves within the cylinder 7 which has a rearward (proximal) end and a forward (distal) end. The pump has preferably a non-flexible neck or nozzle 9 to direct the air flow. Preferably, the nozzle 9 is conical in shape to optimize the control over the air flow possessed by the operator. The outlet opening of the nozzle varies depending on size of the pump. The second handle 11 is optional and when present is securely attached to the body of the pump to facilitate holding the pump with one hand.

In operation, the user holds the pump with one hand using the second handle 11, and with the other hand presses the first handle 1 in the direction of the forward (distal) end of the cylinder 7. Thus, the use of the second handle 11 changes the manipulative steps relative to the method performed when the pump is used without the second handle 11. The use of the second handle 11 improves the method of this invention in that the pump may be steadier and the aim may be improved. The pressing of the first handle 1 forward forces the piston 5 to move forwardly within the cylinder 7 forcing the air out of the nozzle 9. The nozzle 9 can have a stiff or flexible tube 14 connected to it to allow the air output to be directed at the desired spot in places which are difficult to reach. The inlet/outlet port of the tube 14 may vary depending on physical size of the pump in order to optimize the speed of the air exiting the nozzle 9. The presence of a stiff or flexible tube 14 alters the manipulative steps of the method of this invention in that the forward end of the tube 14, not the nozzle 9 is held close to the area to be treated. In this description and claims, the term “close to” is intended to mean up to 2 inches from the target. The presence of a stiff or flexible tube 14 in the nozzle 9 improves the aim of the pump and allows the user to avoid bending over. The pump of FIG. 1 does not have any valves. This pump has the air inlet/outlet port at the forward end of the nozzle 9 and two small air inlet/outlet ports at the rear of the cylinder 7. The nozzle of the pump of this invention is conical shape. The nozzles 9 have no valves in them. In this respect, if a nozzle 9 is described as consisting essentially of a conical wall 15, the term “consisting essentially of” is to be interpreted as excluding valves, which have a substantial effect on the operation of the pump.

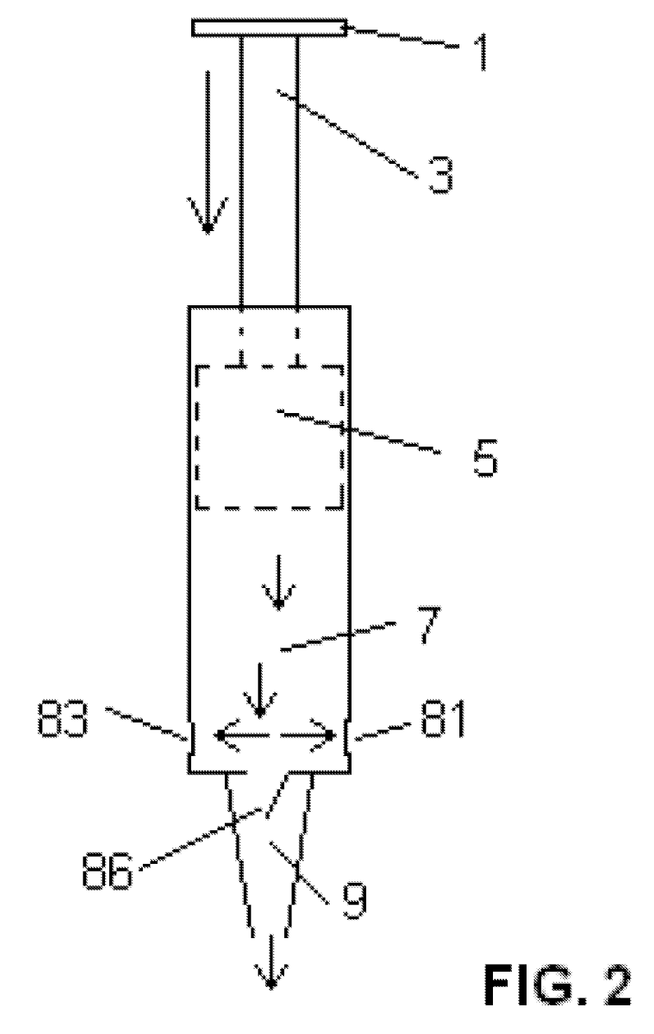

FIG. 2 shows a hand pump similar to that shown in FIG. 1, but with three valves 81, 83, 86 that open in only one direction. The side valves 81, 83 are located adjacent the forward end of the cylinder 7. The user pushes the handle 1 attached to bar 3 forwardly in the cylinder 7. As the piston 5 moves forwardly and forces the air forwardly in the direction shown, the rising air pressure inside the cylinder 7 forces the side valves 81, 83 to close and prevent the air from escaping from the sides of the cylinder 7. Simultaneously, the air pressure inside the cylinder 7 forces the front valve 86 open allowing air to escape out of the nozzle 9 in the direction indicated by the arrow. The addition of a stiff or flexible tubing 14 as in FIG. 1 to the nozzle 9 improves the aiming of the air.

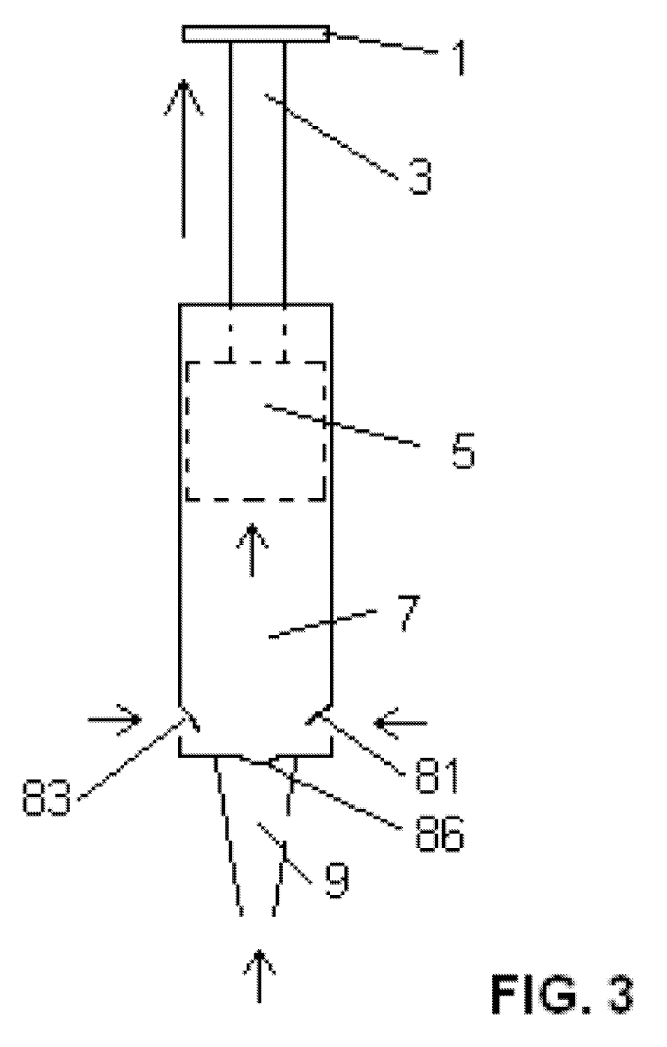

The pumps shown in FIGS. 1 and 2 are useful in creating air flow to blow dust and debris off of computers, computer accessories and related equipment, when the handle 1 is pushed forwardly. FIG. 3 shows what occurs in the pump of FIG. 2 when the handle is pulled rearwardly (proximally). The user pulls the handle 1 attached to the bar 3 rearwardly. As the piston 5 moves rearwardly (proximally) inside the cylinder 7, it creates a vacuum inside the cylinder 7. The outside pressure forces the side valves 81, 83 to open, letting air into the cylinder 7. Simultaneously, the outside pressure forces the front valve 86 to close, thereby preventing the dirty air from moving into the cylinder 7 from the nozzle 9 and the attached stiff tubing 14. Thus, the three valves 81, 83, 86 modify the manipulative steps of the method of this invention in allowing the nozzle 9 or forward end of the stiff tube 14 to be kept close to the computer parts while repeated strokes are made by the user in the blowing mode without dust being returned to the computer parts.

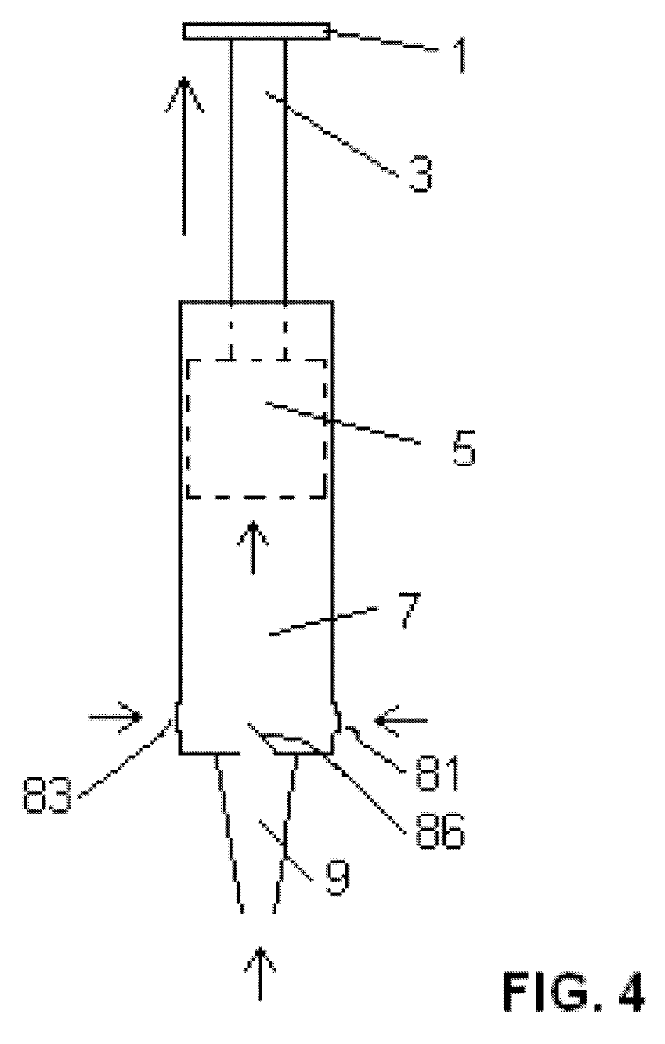

FIG. 4 is a third embodiment of a manual vacuum pump. This pump has three valves 81, 83, 86 that open in only one direction. When the user pulls the handle 1 attached to the bar 3 upwardly, the piston 5 moves up within the cylinder 7, creating a vacuum inside the cylinder 7. The outside air pressure forces the side valves 81, 83 to close, preventing outside air from entering the cylinder 7. Simultaneously, the outside air pressure forces the front valve 86 to open, thereby permitting the outside air to flow into the cylinder 7 from the nozzle 9 opening and any stiff tubing 14 attached thereto and the outside air pressure forces the dust and debris into the cylinder 7. Thus, the pump of the third embodiment cleans computer parts by vacuuming the dust and debris from the parts.

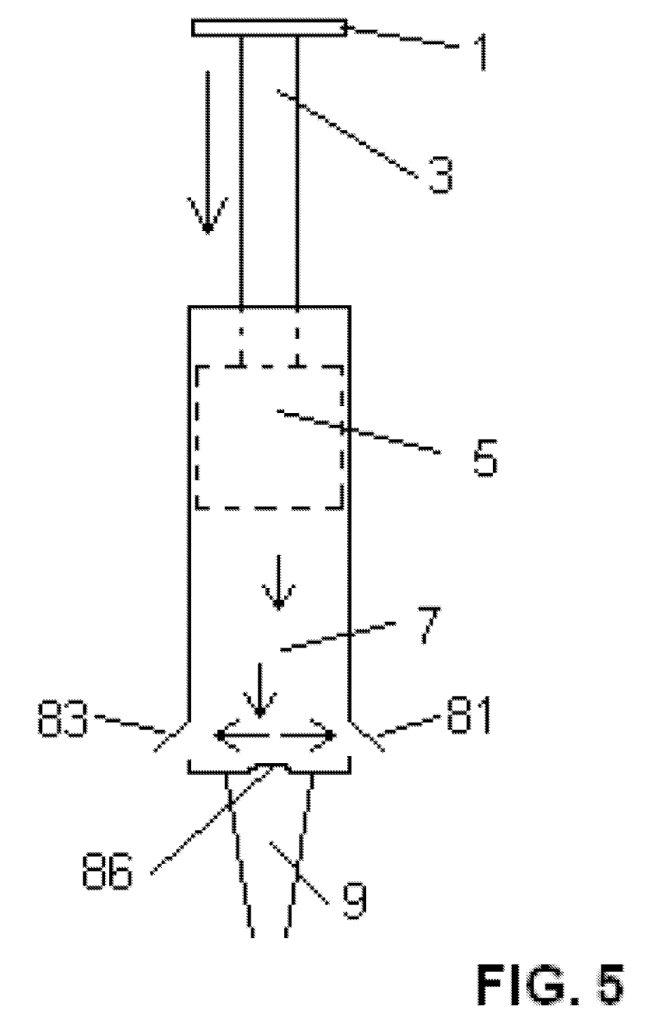

FIG. 5 shows what happens in response to a downward stroke in the pump of the third embodiment shown in FIG. 4. When the cylinder 7 is forced downward, the side valves 81, 83 open to permit the escape of air carrying dust and debris from inside the cylinder 7. Simultaneously, the high air pressure forces the forward valve 86 to close, preventing the air from escaping through the nozzle 9 opening. When the piston 3 is forced up by manual action, as in FIG. 4, dust and debris from the computer parts are sucked into the cylinder 7 and when the piston 5 is forced down, the dust and debris are forced out of the cylinder 7 at a location removed from the computer parts. This is especially true when a stiff tube 14 is attached to the nozzle 9. Thus, the three valves 81, 83, 86 affect the manipulative process in that they allow the nozzle 9 or stiff tube 14 to be held near the computer parts when the pump is used in a vacuuming mode and preventing dust from being returned to the computer parts.

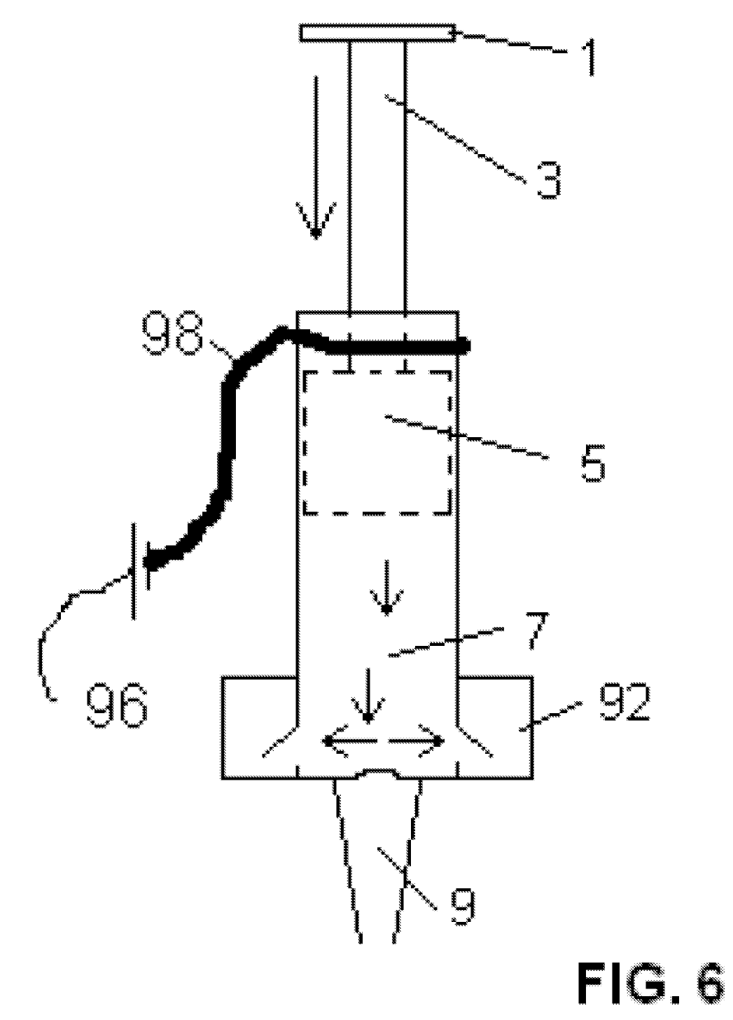

FIG. 6 illustrates a manual vacuum pump of a fourth embodiment. This pump is similar to that shown in FIG. 5 except that it has a dust container 92 surrounding the side valves 81, 83 to collect the dust and debris exiting the side valves 81, 83 to prevent the dust from blowing outside of the cylinder 7 into the room. The container 92 has a filter (not shown) that collects the dust while allowing the air to escape. This provides extra protection against dust which enters the pump from being returned to the computer parts. In addition, the pump of FIG. 6 has an optional anti-static conductive wire or band 98 attached to a local ground source 96. The anti-static wire 98 may be permanently attached to a metallic conductive part of the pump. The purpose of the anti-static wire 98 is to discharge any static electricity that may be present in the pump. Static electricity damages electronic equipment. The anti-static wire 98 prevents any damage to the computer equipment caused by static electricity. In this instance the pump is made from metallic substance that has a static discharge wire permanently attached to it to prevent and reduce the possibility of damage caused by static electricity. The manipulative steps using this device are expanded to include attaching the anti-static wire 98 to a ground.

In using one of the pumps illustrated in FIGS. 1-6, the user provides one of the pumps, holds the pump so that the nozzle 9 or opening of the stiff tube 14 is near the computer part to be treated, forces the handle 1 forwardly to expel air through the nozzle 9 or opening in the stiff tube 14 onto the computer or computer part when the pump is suitable for use as a blowing device, and pulls the handle 1 back in order to be able to repeat the process after the pump is moved to another area to be cleaned. When the pump is suitable for use as a vacuuming device, the user holds the pump near the computer part to be cleaned and pulls the handle 1 rearwardly to vacuum the dust from the computer part. The handle 1 is then forced forwardly to be ready to repeat the process.

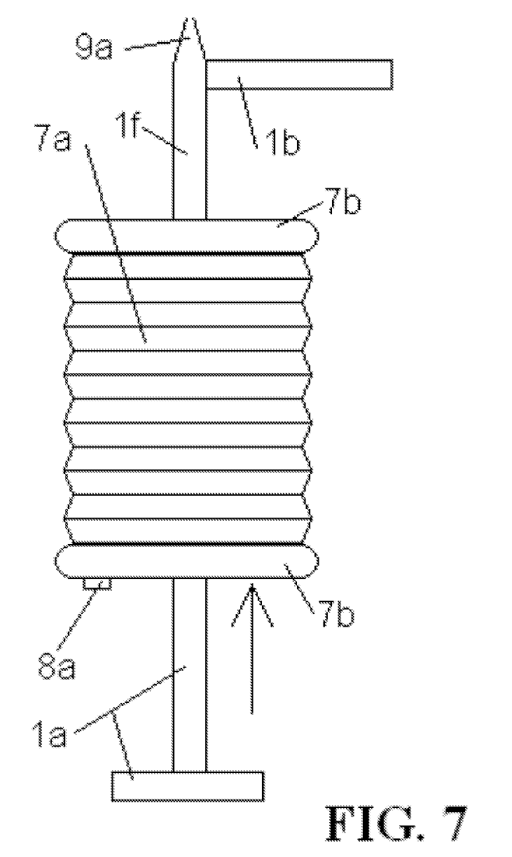

FIG. 7 shows a flexible plastic pump to be used for removing dust. The pump is made of plastic and has two non-flexible ends 7b that sandwich the flexible central part 7a. The central plastic section 7a expands and contracts by force of hand. The pump has two end handles 1a, 1b. The forward handle 1b is attached to a neck portion of which is hollow to allow the air to pass through it. The neck portion has a nozzle 9a at the forward end to direct the air flow.

The user holds the pump with the two handles 1a and 1b and squeezes the pump manually. Since the pump blows air into space to remove dust (not inflating anything) it requires very little energy. The air is forced out of the pump through the nozzle 9a in the direction shown. Then the user pulls the two handles 1a, 1b apart to force air back into the pump and expand the flexible central component 7a. Optionally, the pump may have an air-inlet valve 8a. The valve 8a allows the air into the pump but not out of the pump. The pump may also have a valve (not shown) in the neck portion that allows air to exit the nozzle 9a but will prevent air from getting into the pump through the nozzle 9a.

In performing the method of the present invention, the nozzle 9a of the pump may be held close to the computer part and directed at the area to be cleaned. In one instance, where the pump acts as a blower, the handle 1a is pushed forward to contract the pump and expel air to blow away the dust. In another instance, where the pump acts as a vacuum pump, the handle 7b is pulled back to expand the pump and the dust enters the pump.

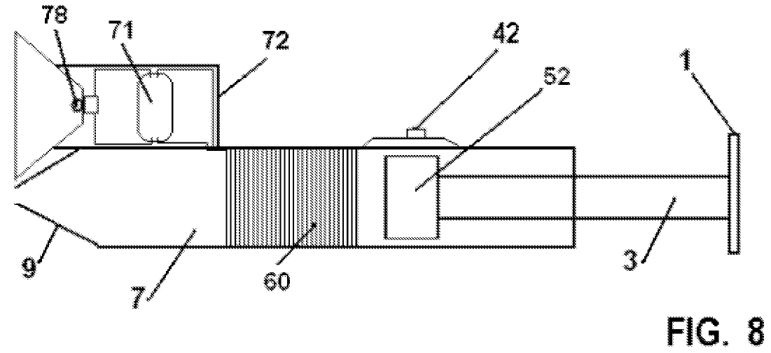

FIG. 8 is a cross-sectional view of the hand pump with a rechargeable flashlight 72 attached to the outside of its cylinder 7. The piston's head is a magnet 52 that moves back and forth through the cylinder 7 when the user pushes and pulls the piston 3 within the cylinder 7. Inside the wall of cylinder 7 is a wrapped wire coil 60. The two ends of the wire coil 60 are attached to a capacitor 71 positioned inside the flashlight 72. Two other wires attach the capacitor 71 to the flashlight's bulb or LED 78—in very similar way as to the method used in shake flashlights. As the user pulls and pushes the piston 3 into the cylinder 7, the magnet 52 passes through the coiled wires 60 wrapped inside the wall of the cylinder 7 thereby charging the capacitor 71 (or a rechargeable battery). In this drawing the rectifier is not shown. When the user turns on the flashlight with the On/Off switch 42, the capacitor 71 discharges its stored electricity through wires connected to the bulb or LED 78, thereby lighting the bulb 78.

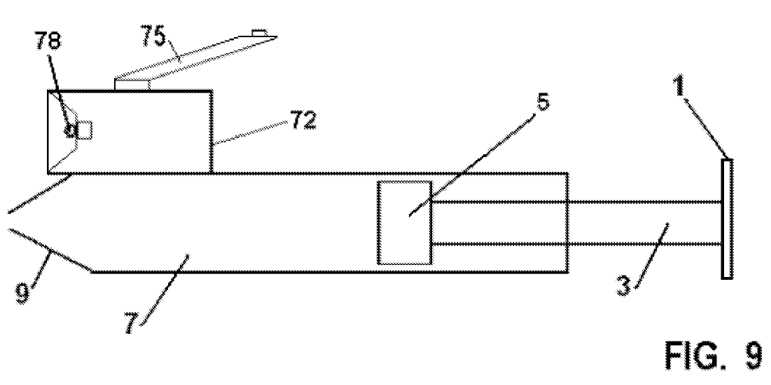

FIG. 9 is a cross-sectional view of the hand pump with a rechargeable crank flashlight attached to its outer cylinder. The rechargeable manual rotating crank flashlight 72 has a rotating crank handle 75 and a bulb or LED 78. The capacitor and other components inside the rechargeable manual rotating crank flashlight 72 are well known and not shown.

Similar to manual chargers on the market today, the present invention's capacitor can connect to various types of electric connectors (not shown because they are old technology) such as USB or cell phone sockets to charge USB devices or cell phones. Various USB devices such as video cameras or speakers can then plug into it for electricity. Instead of or in addition to a flashlight, the dust pump may incorporate a radio, a siren, a laser pointer or any other low voltage electric device or gadget that can use the stored electricity of the capacitor (or a rechargeable battery). The stored electricity can also be used to charge removable rechargeable batteries similar to hand cranked battery charger.

Although the invention has been described and illustrated in detail, it is to be clearly understood that the same is by way of illustration and example, and is not to be taken by way of limitation. The spirit and scope of the present invention are to be limited only by the terms of the appended claims.

What is claimed:

1. A manual air hand pump operated and powered by two hands of a user for blowing dust and debris from computer related equipment, comprising:
a rigid cylinder having a first end and a second end, a handle, a piston movable inside the cylinder, and a nozzle; the piston attached to the handle at the first end of the cylinder; and the cylinder has the nozzle at the second end of the cylinder; operating the air hand pump by holding the pump with one hand so that the nozzle of the hand pump is close to the computer related equipment; and pushing the handle with the other hand so that the handle pushes the piston along the cylinder so as to create a manually controllable blowing of air out of the nozzle, thereby blowing dust and debris from the computer related equipment.

2. The manual air hand pump of claim 1, wherein the nozzle has no valve therein allowing air to freely move in or out of the nozzle.

3. The manual air hand pump of claim 1, wherein the nozzle is conical in shape.

4. The manual air hand pump of claim 1, wherein the computer related equipment includes devices connected to the computer wirelessly.

5. The manual air hand pump of claim 1, further including a flashlight, said flashlight attached to the pump.

6. The manual air hand pump of claim 5, further including a rechargeable crank flashlight, said rechargeable crank flashlight attached to the pump.

7. The manual air hand pump of claim 1, further including, a crank electric generator, said crank electric generator attached to the pump.

8. The manual air hand pump of claim 1, wherein the nozzle has an outlet opening diameter that varies relative to the physical size of the pump.

9. The manual air hand pump of claim 1, wherein the nozzle is screwed to the cylinder.

10. The manual air hand pump of claim 1, wherein the computer related equipment includes a computer table and desktop.

11. A method for removing dust and debris from computer related equipment comprising:
providing an air hand pump operated and powered by two hands of a user; the air hand pump having a rigid cylinder having a first end and a second end, a handle, a piston movable inside the cylinder, and a nozzle; the piston attached to the handle at the first end of the cylinder; and the cylinder has the nozzle at the second end of the cylinder; operating the hand pump by holding the pump with one hand so that the nozzle of the hand pump is close to the computer related equipment; and pushing the handle with the other hand so that the handle pushes the piston along the cylinder so as to create a manually controllable blowing of air out of the nozzle, thereby removing the dust and the debris from the computer related equipment.

12. The method of claim 11, wherein the nozzle has no valve therein allowing air to freely move in or out of the nozzle.

13. The method of claim 11, wherein the nozzle is conical in shape.

14. The method of claim 11, wherein the computer related equipment includes devices connected to the computer wirelessly.

15. The method of claim 11, further including a flashlight, said flashlight attached to the pump.

16. The method of claim 15, further including a rechargeable crank flashlight, said rechargeable crank flashlight attached to the pump.

17. The method of claim 11, wherein the computer related equipment includes a computer table and desktop.

18. A method for removing heavier than dust debris from a surface comprising:
providing a hand pump operated manually by a user; the hand pump having a cylinder having a first end and a second end, a handle, a piston movable inside the cylinder, and a nozzle; the piston attached to the handle at the first end of the cylinder; and the cylinder has the nozzle at the second end of the cylinder; wherein the nozzle is conical in shape; operating the hand pump by holding the pump with one hand so that the nozzle of the hand pump is close to the computer related equipment; and pushing the handle with the other hand so that the handle pushes the piston along the cylinder so as to create a manually controllable blowing of air out of the nozzle, thereby removing the dust and the debris from the computer related equipment.

19. The method of claim 18 wherein the surface is in a clean manufacturing environment.

20. The method of claim 18 wherein the debris is embedded in a surface deposit.
